(19) United States
(12) Patent Application Publication
(10) Pub. No.: US 2025/0317765 A1
(43) Pub. Date: Oct. 9, 2025

(54) MANAGING MULTIPLE RRC CONNECTIONS SUPPORT OF MUSIM UE IN WIRELESS NETWORK

(71) Applicant: Samsung Electronics Co., Ltd., Suwon-si, Gyeonggi-do (KR)

(72) Inventors: Aby Kanneath ABRAHAM, Bangalore (IN); Vinay Kumar SHRIVASTAVA, Bangalore (IN); Sriganesh RAJENDRAN, Bangalore (IN)

(21) Appl. No.: 18/863,131

(22) PCT Filed: May 3, 2023
(86) PCT No.: PCT/KR2023/006056

§ 371 Date: Nov. 5, 2024

(30) Foreign Application Priority Data
May 5, 2022 (IN) 202241026247
Apr. 26, 2023 (IN) 2022 41026247

(51) Int. Cl. H04W 24/08; H04W 8/24; H04W 76/20

(52) U.S. Cl. CPC H04W 24/08; H04W 8/24; H04W 76/20

(57) ABSTRACT

The disclosure relates to a 5G or 6G communication system for supporting a higher data transmission rate. Embodiments herein provide method for managing multiple RRC connections support of MUSIM UE (100) in wireless network (1000) by MUSIM UE. The method includes detecting an event associated with a second SIM of a plurality of SIMs of the UE when a first SIM of the plurality of SIMs is in a connected state. Further, the method includes determining a MUSIM operation comprising a change in capability of a measurement gap and NCSG based on the event. Further, the method includes sending assistance information for the MUSIM operation using the first SIM to first network apparatus (200a). Further, the method includes receiving a request message with a gap configuration based on the change in capability of the measurement gap and the NCSG. Further, the method includes configuring the received gap configuration from the first network apparatus. Further, the method includes sending a response message to the first network apparatus.

### TECHNICAL FIELD

This application is based on and derives the benefit of Indian Provisional Application 202241026247 filed on 5 May 2022, the contents of which are incorporated herein by reference. The present disclosure relates to a wireless communication, and more specifically related to methods and systems for operation of Dual Receiver (Rx)/Dual Transmitter (Tx) Multi-Subscriber Identity Module (MUSIM) User Equipment (UE) in a 5th Generation (5G) network (NW).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The principal object of the embodiments herein is to provide a methods and systems for operation of Multi-Subscriber Identity Module (MUSIM) devices supporting multiple RRC connections simultaneously like Dual Receiver (Rx)/Dual Transmitter (Tx) Multi-Subscriber Identity Module (MUSIM) User Equipment (UE) in a 5th Generation (5G) network (NW).

Another object of the embodiments herein is to manage multiple RRC connections support of a MUSIM UE in a wireless network.

Another object of the embodiments herein is to provide that the MUSIM UE reports temporary capability restrictions for measurement capabilities such as gaps to the network.

Another object of the embodiments herein is to handle measurement gap requirements during temporary capability restriction for MUSIM UE.

### Solution to Problem

Accordingly, the embodiment herein is to provide a method for managing multiple RRC connections support of a MUSIM UE in a wireless network. The method includes detecting, by the MUSIM UE, an event associated with a second SIM of a plurality of SIMs of the MUSIM UE when a first SIM of the plurality of SIMs is in a connected state. The first SIM is associated with a first network apparatus and the second SIM is associated with a second network apparatus. Further, the method includes determining, by the MUSIM UE, a MUSIM operation comprising a change in capability of at least one of measurement gap and network controlled small gaps (NCSG) based on the event associated with the second SIM. Further, the method includes sending, by the MUSIM UE, assistance information for the MUSIM operation using the first SIM to the first network apparatus. Further, the method includes receiving, by the MUSIM UE, a request message with a gap configuration based on the change in capability of at least one of the measurement gap and the NCSG. Further, the method includes configuring, by the MUSIM UE, the received gap configuration from the first network apparatus. Further, the method includes sending, by the MUSIM UE, a response message to the first network apparatus.

In an embodiment, the event associated with the second SIM includes at least one of a transition of the second SIM from one of an idle state or an inactive state to a connected state, a transition of the second SIM from the connected state to one of the idle state or the inactive state, configuration of the second SIM with a carrier aggregation, release of the second SIM with the carrier aggregation, configuration of the second SIM with a dual connectivity, release of the second SIM with the dual connectivity, removal of the second SIM from the MUSIM UE, addition of the second SIM into the MUSIM UE, activation of a DSDS mode at the MUSIM UE, and activation of a Dual Stack-Dual Active (DSDA) mode at the MUSIM UE.

In an embodiment, sending, by the MUSIM UE, the assistance information for the MUSIM operation using the first SIM to the first network apparatus includes detecting, by the MUSIM UE, whether a band filter is configured at the MUSIM UE by the first network apparatus for reporting the change in capability of at least one of the measurement gap and the NCSG, and performing, by the MUSIM UE, one of sending the assistance information for the MUSIM operation for bands included in the band filter, when the band filter is configured at the MUSIM UE, and sending the assistance information for the MUSIM operation for all bands that are supported after change in capabilities based on the event associated with the second SIM, when the band filter is not configured at the MUSIM UE by the first network apparatus.

In an embodiment, the MUSIM UE sends the assistance information for the MUSIM operation for the bands included in the band filter in one of a requestedTargetBandFilterNR message, a requestedTargetBandFilterNCSG message, and a requestedTargetBandFilterNCSG-EUTRA message.

In an embodiment, the method includes receiving, by the MUSIM UE, an indication to send the change in capabilities of the MUSIM UE from the first network apparatus. Further, the method includes sending, by the MUSIM UE, the assistance information for the MUSIM operation using the first SIM to the first network apparatus upon receiving the indication from the first network apparatus.

In an embodiment, the indication is received in one of a Musim-Capability AssistanceConfig IE, a NeedForGaps IE, a NeedForNCSG IE, a NeedForGapsConfigNR IE, a NeedForNCSG-ConfigNR IE, and a NeedForNCSG-ConfigEUTRA IE contained in at least one of RRC Reconfiguration message and RRC Resume message.

In an embodiment, the assistance information is send in UEAssistanceInformation RRC message.

In an embodiment, the method includes initiating, by the MUSIM UE, a timer after sending the assistance information for the MUSIM operation to the first network apparatus, wherein the MUSIM UE does not report any change of capabilities or change in gap requirements or gap and NCSG requirement to the first network apparatus till the timer is stopped or expired.

In an embodiment, the request message is one of a RRC Reconfiguration message and a RRC Resume message.

In an embodiment, the response message is one of a RRC Reconfiguration complete message, and a RRC Resume Complete message, and wherein the assistance information is included in the response message

In an embodiment, the UE pauses the measurements which require changed measurement gaps as send in the response message, receives a new RRC Reconfiguation message according to the changed capabilities, applies the received gap configuration and resumes the measurements.

Accordingly, the embodiment herein is to provide a method for managing multiple RRC connections support of a MUSIM UE in a wireless network. The method includes sending, by the first network apparatus, an indication to a MUSIM UE for a MUSIM operation. The MUSIM operation includes reporting a change in capabilities of at least one of measurement gap and NCSG based on an event associated with a second SIM of a plurality of SIMS of the MUSIM UE. Further, the method includes receiving, by the first network apparatus, assistance information for the MUSIM operation from the MUSIM UE using a first SIM of the plurality of SIMs of the MUSIM UE in response to the indication. Further, the method includes sending, by the first network apparatus, a request message with a gap configuration based on the change in capability of at least one of the measurement gap and the NCSG. Further, the method includes receiving, by the first network apparatus, a response message from the MUSIM UE indicating configuration of the gap configuration at the MUSIM UE.

In an embodiment, the method includes transferring, by the first network apparatus, the change in capability of at least one of the measurement gap and the NCSG at the MUSIM UE to MUSIM operator of a target network apparatus during handover.

In an embodiment, receiving, by the first network apparatus, the assistance information for the MUSIM operation comprises one of: receiving the assistance information for the MUSIM operation for bands included in a band filter, when the band filter is configured at the MUSIM UE by the first network apparatus, and receiving the assistance information for the MUSIM operation for all bands that are supported after change in capabilities based on the event associated with the second SIM, when the band filter is not configured at the MUSIM UE by the first network apparatus.

In an embodiment, the method includes sending, by the first network apparatus, a band filter to the MUSIM UE for reporting the change in capability of at least one of the measurement gap and the NCSG.

Accordingly, the embodiment herein is to provide a MUSIM UE for managing multiple RRC connections support in a wireless network. The MUSIM UE includes a multiple RRC connection support controller communicatively coupled to a processor and a memory. The multiple RRC connection support controller is configured to detect an event associated with a second SIM of a plurality of SIMs of the MUSIM UE when a first SIM of the plurality of SIMs is in a connected state. The first SIM is associated with a first network apparatus and the second SIM is associated with a second network apparatus. Further, the multiple RRC connection support controller is configured to determine a MUSIM operation comprising a change in capability of at least one of measurement gap and network controlled small gaps (NCSG) based on the event associated with the second SIM. Further, the multiple RRC connection support controller is configured to send assistance information for the MUSIM operation using the first SIM to the first network apparatus. Further, the multiple RRC connection support controller is configured to receive a request message with a gap configuration based on the change in capability of at least one of the measurement gap and the NCSG. Further, the multiple RRC connection support controller is configured to configure the received gap configuration from the first network apparatus. Further, the multiple RRC connection support controller is configured to send a response message to the first network apparatus.

Accordingly, the embodiment herein is to provide a first network apparatus for managing multiple RRC connections support in a wireless network. The first network apparatus includes a multiple RRC connection support controller communicatively coupled to a processor and a memory. The multiple RRC connection support controller is configured to send an indication to a MUSIM UE for a MUSIM operation. The MUSIM operation includes reporting a change in capabilities of at least one of measurement gap and NCSG based on an event associated with a second SIM of a plurality of SIMS of the MUSIM UE. Further, the multiple RRC connection support controller is configured to receive assistance information for the MUSIM operation from the MUSIM UE using a first SIM of the plurality of SIMs of the MUSIM UE in response to the indication. Further, the multiple RRC connection support controller is configured to send a request message with a gap configuration based on the change in capability of at least one of the measurement gap and the NCSG. Further, the multiple RRC connection support controller is configured to receive a response message from the MUSIM UE indicating configuration of the gap configuration at the MUSIM UE.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### Advantageous Effects of Invention

Accordingly, the embodiment herein is to provide a method for managing multiple RRC connections support of a MUSIM UE in a wireless network.

### BRIEF DESCRIPTION OF DRAWINGS

The method, the MUSIM UE and the first network apparatus are illustrated in the accompanying drawings, throughout which like reference letters indicate corresponding parts in the various figures. The embodiments herein will be better understood from the following description with reference to the drawings, in which:

FIG. 1 illustrates a wireless network for managing multiple RRC connections support of a MUSIM UE, according to the embodiments as disclosed herein;

FIG. 2 shows various hardware components of the MUSIM UE, according to the embodiments as disclosed herein;

FIG. 3 shows various hardware components of a first network apparatus, according to the embodiments as disclosed herein;

FIG. 4 is a flow chart illustrating a method, implemented by the MUSIM UE, for managing the multiple RRC connections support of the MUSIM UE in the wireless network, according to the embodiments as disclosed herein;

FIG. 5 is a flow chart illustrating a method, implemented by the first network apparatus, for managing the multiple RRC connections support of the MUSIM UE in the wireless network, according to the embodiments as disclosed herein;

FIG. 6 is an example flow diagram illustrating a scenario of reporting gap requirements, according to the embodiments as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### Mode for the Invention

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiment herein is to provide a method for managing multiple RRC connections support of a MUSIM UE in a wireless network. The method includes detecting, by the MUSIM UE, an event associated with a second SIM of a plurality of SIMs of the MUSIM UE when a first SIM of the plurality of SIMs is in a connected state. The first SIM is associated with a first network apparatus and the second SIM is associated with a second network apparatus. Further, the method includes determining, by the MUSIM UE, a MUSIM operation comprising a change in capability of at least one of measurement gap and NCSG based on the event associated with the second SIM. Further, the method includes sending, by the MUSIM UE, assistance information for the MUSIM operation using the first SIM to the first network apparatus. Further, the method includes receiving, by the MUSIM UE, a request message with a gap configuration based on the change in capability of at least one of the measurement gap and the NCSG. Further, the method includes configuring, by the MUSIM UE, the received gap configuration from the first network apparatus. Further, the method includes sending, by the MUSIM UE, a response message to the first network apparatus.

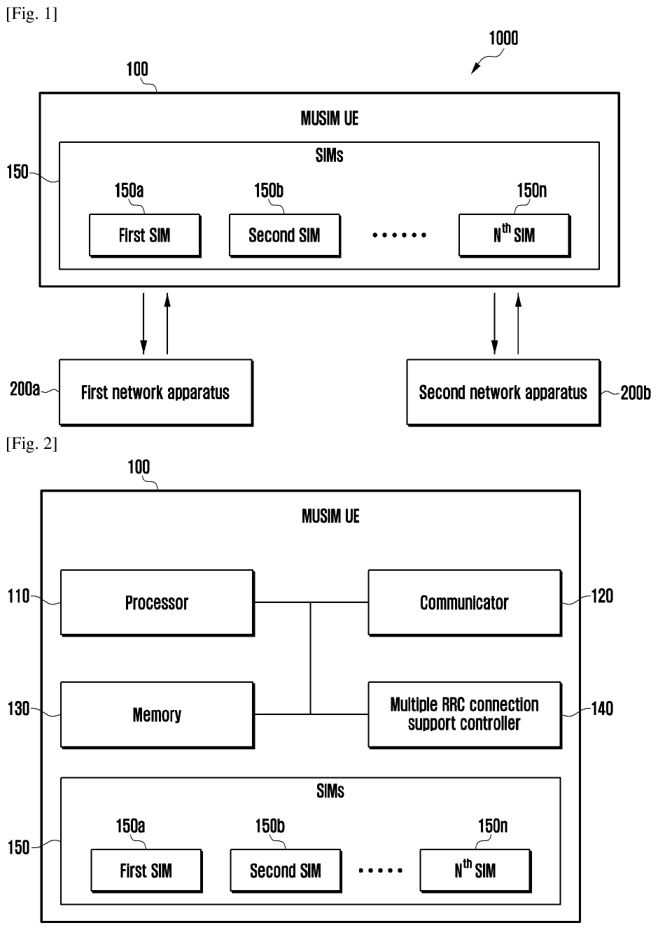

Referring now to the drawings and more particularly to FIGS. 1 through 6, where similar reference characters denote corresponding features consistently throughout the figures, there are shown preferred embodiments.

Multi-SIM devices (e.g., MUSIM UE) and simultaneous RRC connection support devices that host more than one Subscriber Identity Module (SIM) to have the facility to connect to two or more different Networks (NWs) in order to avail different data plans, have user profiles like home and office, increased connectivity/reliability with multiple connections etc. are becoming very popular. One or more of the multiple SIMs can be engaged in paging reception, system information block (SIB) acquisition, measurements, data or voice call, Multicast and Broadcast Service (MBS) reception, emergency call, access stratum (AS) signaling, Non-access stratum (NAS) signaling and so on. Some of the operations are periodic like paging, measurements and some of the operations are aperiodic and/or un-deterministic like signaling. Further, duration required to complete the operation may also be fixed or unpredictable.

There are different flavours of Multi-SIM devices like Single Receiver (Rx)-Single Transmitter (Tx), Dual Rx-Single Tx, Dual Tx-Single Rx and Dual Rx-Dual Tx depending up on the number of Rx (Reception) chain and Tx (Transmission) chain. A Rx or Tx chain includes radio frequency (RF) circuitries and associated hardware and software components for reception and transmission respectively. A Dual Rx-Dual Tx device can normally support simultaneous RRC connections on its multiple subscriptions. The Dual Rx-Dual Tx device is also sometimes called as a Dual Stack-Dual Active (DSDA) device. The device may be also possible for Single Rx-Single Tx, Dual Rx-Single Tx, Dual Tx-Single Rx devices to support multiple simultaneous RRC connections through some methods for sharing their Rx and Tx chain and switching based on need or requirements.

Radio Resource Control (RRC) States-In a New Radio (NR), the RRC can be in one of the three states such as RRC_IDLE, RRC_INACTIVE or RRC_CONNECTED. A RRC_CONNECTED UE is in CM-CONNECTED (i.e. Connected to a 5G core network) and can do unicast and multicast/broadcast traffic with the network. The network stores a UE Access Stratum (AS) context, knows the UE at a cell level and controls the UE mobility. The UE may perform measurements and report to the network, provides channel quality and feedback information etc.

The RRC_INACTIVE is a state where the UE remains in CM-CONNECTED and can move within an area configured by a NG-RAN (5G RAN consisting of gNB(s)) without notifying NG-RAN. In the RRC_INACTIVE, a last serving gNB node keeps the UE context and the UE-associated NG connection (i.e. the connection to the core network). Since the RRC configurations and the connection to a core network is kept in the RRC_INACTIVE, the UE can transition immediately to the RRC connected state and performs data transfer with the core network/applications. The UE initiates transition to RRC_CONNECTED from RRC_INACTIVE by sending a RRC resume request.

In the RRC_IDLE UE or a gNB doesn't store any Access Stratum (AS) context. The UE is in the CM_IDLE (there is no connection to the core network). The UE sets up a new connection by sending a RRC Setup Request message and the gNB sends the RRC setup message to transition to the RRC connected. The UE and the network (both radio access network (RAN) and core network) exchanges messages to move the UE to the CM_CONNECTED.

UE Capabilities-In the technology like 5G NR, different UEs may have different hardware and software capabilities. Varying capabilities across devices could be hardware capabilities including radio frequency capabilities like bands or band combinations supported, processing capabilities (e.g. baseband computational capabilities), software capabilities like the support of various features, layer 1 capabilities, layer 2 capabilities, layer 3 capabilities and so on.

In general, the UE reports UE radio access capabilities which are static at least when the network requests the capabilities. In order to limit signaling overhead, the gNB (e.g., 5G NR base station) can request the UE to provide NR capabilities for a restricted set of bands. When responding, the UE can skip a subset of the requested band combinations when the corresponding UE capabilities are the same. If supported by the UE and the network, the UE may provide an identifier (ID) in a NAS signaling that represents its radio capabilities for one or more RATs in order to reduce signaling overhead. The ID may be assigned either by a manufacturer or by a serving Public Land Mobile Network (PLMN). The manufacturer-assigned ID corresponds to a pre-provisioned set of capabilities. In the case of the PLMN-assigned ID, assignment takes place in the NAS signaling. Detailed list of the UE capabilities that are exchanged based on aforementioned methods is specified in 3GPP technical specifications (TS) like TS 38.306. The gNB provides the UE with various configurations/features through RRC messages like RRC reconfiguration or RRC resume based on the reported UE capability.

In the MUSIM device which supports simultaneous RRC Connections on multiple USIMs, the UE capabilities of the RRC_CONNECTED USIM in the MUSIM device may change when other USIM(s) move from the RRC_IDLE or the RRC_INACTIVE to the RRC_CONNECTED or vice versa (for example) and the supported bands may change.

Measurement Gaps-In wireless technologies like NR and Long Term Evolution (LTE), a RRC connected UE performs various measurements for Radio resource management (RRM) purpose, positioning etc. For the RRM, the UE measures the reference signals such as SSB, CSI-RS etc. and reports the measurement results to the network.

According to the NR specification TS 38.300, measurements to be performed by the UE for connected mode mobility are classified in at least four measurement types:
Intra-frequency NR measurements;
Inter-frequency NR measurements;
Inter-RAT measurements for E-UTRA; and
Inter-RAT measurements for UTRA.

For each measurement type, one or several measurement objects can be defined (a measurement object defines e.g. the carrier frequency to be monitored). For each measurement object, one or several reporting configurations can be defined (a reporting configuration defines the reporting criteria). Three reporting criteria are used such as event triggered reporting, periodic reporting and event triggered periodic reporting. The association between a measurement object and a reporting configuration is created by a measurement identity (a measurement identity links together one measurement object and one reporting configuration of the same Radio Access technology (RAT)). The measurements identity is used as well when reporting results of the measurements.

For positioning, the UE may report SSB/CSI-RS measurements and may also report measurements based on additional reference signals like Positioning Reference Signals (PRS).

When the UE needs to measure inter frequency NR or inter-RAT measurements or intra frequency measurements outside the active downlink BWP when SSB is not completely contained in the active DL BWP, the UE may use the measurement gaps. The measurement gaps are configured by the network (for e.g. gNB in NR) and there will not be any transmission or reception during the gap period. A measurement gap configuration includes a gap offset, gap length, repetition period and measurement gap timing advance. The gap offset specifies the sub-frame where the start of measurement gap occurs. The gap length gives the duration of the gap while the repetition period defines how often the measurement gap can occur.

NeedForGaps-the UE reports a NeedForGaps to indicate whether the UE needs gaps for measuring specific NR bands. In Release 17, the NeedForGaps has been extended so that the UE can report whether the UE needs gaps or a network controlled small gaps (NCSG) for measuring specific NR bands. Starting from 3GPP Release 17, the UE can also indicate whether the UE needs the gaps or the NCSG for measuring E-UTRA bands.

The network configures the UE to provide the measurement gap requirement information of NR target bands by setting needForGapsConfigNR to setup in the RRC Reconfiguration or RRC Resume. In Release 17, the network configures the UE to provide the measurement gap and the NCSG requirement information of the E-UTRA target bands by setting needForNCSG-ConfigEUTRA to setup in the RRC Reconfiguration or a RRC Resume. Similarly, in R17, the network configures the UE to provide the measurement gap and the NCSG requirement information of NR target bands by setting needForNCSG-ConfigNR to setup in the RRC Reconfiguration or the RRC Resume.

Once configured, the UE keeps the configuration until released or modified and informs the network on the gap requirements for the NR bands or gap and NCSG requirements for the NR and E-UTRA bands. The UE includes gap (or gap and NCSG) requirements in the RRC Resume Complete and the RRC Reconfiguration Complete. If the gap or gap and NCSG requirements change after a reconfiguration, the UE reports the changed requirements in the RRC Reconfiguration complete.

The network may also configure the UE with a band filter. If the band filter is configured, the UE reports gap requirements or gap and the NCSG requirements for the NR and the E-UTRA bands those are included in the band filter. If the band filter is not configured, the UE reports the gap requirements or gap and NCSG requirements for all the bands supported by the UE.

An extract from Release 17 v17.0.0 RRC specification on NeedForgaps or NeedforNCSG reporting during RRC Reconfiguration is given below:

```
    2> if the RRCReconfiguration message was received via
SRB1, but not within mrdc-SecondaryCellGroup or E-UTRA
RRCConnectionReconfigurationor E-
UTRARRCConnectionResume:
        3> if the UE is configured to provide the
  measurement gap requirement information of NR target
  bands:
          4> if the RRCReconfiguration message includes
    the needForGapsConfigNR; or
        4>  if the NeedForGapsInfoNR information is
    changed compared to last time the UE reported this
    information:
          5> include the NeedForGapsInfoNR and set
      the contents as follows:
            6> include intraFreq-needForGap and set
        the gap requirement information of intra-
        frequency measurement for each NR serving cell;
            6> if requestedTargetBandFilterNR is
        configured, for each supported NR band that is
        also included in requestedTargetBandFilterNR,
        include an entry in interFreq-needForGap and set
        the gap requirement information for that band;
        otherwise, include an entry in interFreq-
        needForGap and set the corresponding gap
        requirement information for each supported NR
        band;
      3> if the UE is configured to provide the
  measurement gap and NCSGrequirementinformation of
  NRtarget bands:
        4>  if the RRCReconfiguration message includes
  the needForNCSG-ConfigNR; or
        4>  if the needForNCSG-InfoNR information is
  changed compared to last time the UE reported this
  information:
          5> include the NeedForNCSG-InfoNR and set
    the contents as follows:
            6> include intraFreq-needForNCSG and set
      the gap and NCSG requirement information of
```

```
      intra-frequency measurement for each NR serving
      cell;
        6> if requestedTargetBandFilterNCSG-NR
      is configured, for each supported NR band
      included in requestedTargetBandFilterNCSG-NR,
      include an entry in interFreq-needForNCSG and
      set the NCSG requirement information for that
      band; otherwise, include an entryfor each
      supported NR bandininterFreq-needForNCSG and set
      the corresponding NCSG requirement information;
    3> if the UE is configured to provide the
measurement gap and NCSGrequirementinformation of
E-UTRA target bands:
      4>  if the RRCReconfiguration message includes
  the needForNCSG-ConfigEUTRA; or
      4>  if the needForNCSG-InfoEUTRA information is
  changed compared to last time the UE reported this
  information:
        5> include the NeedForNCSG-InfoEUTRA and
    set the contents as follows:
          6> if requestedTargetBandFilterNCSG-
      EUTRA is configured, for each supported E-UTRA
      band included in requestedTargetBandFilterNCSG-
      EUTRA, include an entry in needForNCSG-EUTRA and
      set the NCSG requirement information for that
      band; otherwise, include an entry for each
      supported E-UTRAband inneedForNCSG-EUTRA and set
      the corresponding NCSG requirement information;
```

Similarly, an extract from Release 17 v17.0.0 RRC specification on NeedForgaps or NeedforNCSG reporting during RRC Resume is given below:

```
    2> if the UE is configured to provide the measurement gap
requirement information of NR target bands:
      3> include the NeedForGapsInfoNR and set the
  contents as follows:
        4> include intraFreq-needForGap and set the gap
    requirement information of intra-frequency measurement
    for each NR serving cell;
        4>  if requestedTargetBandFilterMR is configured,
    for each supported NR band that is also included in
    requestedTargetBandFilterNR, include an entry in
    interFreq-needForGap and set the gap requirement
    information for that band; otherwise, include an entry
    in interFreq-needForGap and set the corresponding gap
    requirement information for each supported NR band;
    2> if the UE is configured to provide the measurement gap
and NCSGrequirementinformation of NRtarget bands:
      3> include the NeedForNCSG-InfoNR and set the
  contents as follows:
        4> include intraFreq-needForNCSG and set the gap
    andNCSG requirement information of intra-frequency
    measurement for each NR serving cell;
        4> if requestedTargetBandFilterNCSG-NR is
    configured, for each supported NR band included in
    requestedTargetBandFilterNCSG-NR, include an entry in
    interFreq-needForNCSG and set the NCSG requirement
    information for that band; otherwise, include an entry
    for each supported NR band in interFreq-needForNCSG and
    set the corresponding NCSG requirement information;
    2> if the UE is configured to provide the measurement gap
and NCSGrequirementinformation of E-UTRA target bands:
      3> include the NeedForNCSG-InfoEUTRA and set the
  contents as follows:
        4>  if  requestedTargetBandFilterNCSG-EUTRA  is
    configured, for each supported E-UTRA band included in
    requestedTargetBandFilterNCSG-EUTRA, include an entry
    in needForNCSG-EUTRA and set the NCSG requirement
    information for that band; otherwise, include an entry
    for each supported E-UTRA band in needForNCSG-EUTRA
    and set the corresponding NCSG requirement information;
```

It is desired to address the above mentioned disadvantages or other short comings or at least provide a useful alternative.

FIG. 1 illustrates a wireless network (1000) for managing multiple RRC connections support of a MUSIM UE (100), according to the embodiments as disclosed herein. In an embodiment, the wireless network (1000) includes the MUSIM UE (100) including a plurality of SIMs (e.g., USIMs) (150a-150n), a first network apparatus (200a), and a second network apparatus (200b). The wireless network (1000) can be, for example, but not limited to a fourth generation (4G) network, a fifth generation (5G) network, an Open Radio Access Network (ORAN) or the like.

The MUSIM UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The first network apparatus (200a) and the second network apparatus (200b) can be, for example, but not limited to a gNB, a eNB, a new radio (NR) trans-receiver.

The MUSIM UE (100) detects an event associated with a second SIM (150b) of the plurality of SIMs (150a-150n) of the MUSIM UE (100) when a first SIM (150a) of the plurality of SIMs (150a-150n) is in the connected state. The first SIM (150a) is associated with the first network apparatus (200a) and the second SIM (150b) is associated with the second network apparatus (200b). The event associated with the second SIM (150b) can be, for example, but not limited to a transition of the second SIM (150b) from one of an idle state or an inactive state to a connected state, a transition of the second SIM (150b) from the connected state to one of the idle state or the inactive state, configuration of the second SIM (150b) with a carrier aggregation, release of the second SIM (150b) with the carrier aggregation, configuration of the second SIM (150b) with a dual connectivity, release of the second SIM (150b) with the dual connectivity, removal of the second SIM (150b) from the MUSIM UE (100), addition of the second SIM (150b) into the MUSIM UE (100), activation of a DSDS mode at the MUSIM UE (100), and activation of a Dual Stack-Dual Active (DSDA) mode at the MUSIM UE (100).

Based on the event associated with the second SIM (150b), the MUSIM UE (100) determines a MUSIM operation comprising a change in capability of at least one of measurement gap and a NCSG.

Further, the MUSIM UE (100) sends assistance information for the MUSIM operation using the first SIM (150a) to the first network apparatus (200a). In an embodiment, the MUSIM UE (100) detects whether a band filter is configured at the MUSIM UE (100) by the first network apparatus (200a) for reporting the change in capability of at least one of the measurement gap and the NCSG. In an embodiment, the MUSIM UE (100) sends the assistance information for the MUSIM operation for bands included in the band filter, when the band filter is configured at the MUSIM UE (100). In another embodiment, the MUSIM UE (100) sends the assistance information for the MUSIM operation for all bands that are supported after change in capabilities based on the event associated with the second SIM (150b), when the band filter is not configured at the MUSIM UE (100) by the first network apparatus (200a). The assistance information is send in UEAssistanceInformation RRC message. Alternatively, the assistance information is included in the response message

Based on the change in capability of at least one of the measurement gap and the NCSG, the MUSIM UE (100) receives a request message with a gap configuration. The request message is one of a RRC Reconfiguration message and a RRC Resume message. Further, the MUSIM UE (100) configures the received gap configuration from the first network apparatus (200a). Further, the MUSIM UE (100) sends a response message to the first network apparatus (200a). The response message is one of a RRC Reconfiguration complete message, and a RRC Resume Complete message.

Further, the MUSIM UE (100) sends the assistance information for the MUSIM operation for the bands included in the band filter in one of a requestedTargetBandFilterNR message, a requestedTargetBandFilterNCSG message, and a requestedTargetBandFilterNCSG-EUTRA message.

Further, the MUSIM UE (100) receives an indication to send the change in capabilities of the MUSIM UE (100) from the first network apparatus (200a). Upon receiving the indication from the first network apparatus (200a), the MUSIM UE (100) sends the assistance information for the MUSIM operation using the first SIM (150a) to the first network apparatus (200a). The indication is received in one of a Musim-Capability AssistanceConfig IE, a NeedForGaps IE, a NeedForNCSG IE, a NeedForGapsConfigNR IE, a NeedForNCSG-ConfigNR IE, and a NeedForNCSG-ConfigEUTRA IE contained in at least one of RRC Reconfiguration message and RRC Resume message.

Further, the MUSIM UE (100) initiates a timer after sending the assistance information for the MUSIM operation to the first network apparatus (200a), where the MUSIM UE (100) does not report any change of capabilities or change in gap requirements or gap and NCSG requirement to the first network apparatus (200a) till the timer is stopped or expired.

Further, the MUSIM UE (100) pauses the measurements which require changed measurement gaps as send in the response message, receives a new RRC Reconfiguation message according to the changed capabilities, applies the received gap configuration and resumes the measurements.

In an example, let us consider the case of the MUSIM device (or MUSIM UE (100)) with two USIMs-USIM-A and USIM-B. The USIM-A is in the RRC_CONNECTED and the USIM-B is in the RRC_IDLE or RRC_INACTIVE. The MUSIM UE (100) supports multiple RRC connections simultaneously. That is, the MUSIM UE (100) is possible for both USIM-A and USIM-B to be in RRC_CONNECTED at the same time. The terms “MUSIM device” and the “MUSIM UE” are used interchangeably in the patent disclosure.

If the USIM-B moves from the RRC_IDLE or the RRC_INACTIVE to the RRC_CONNECTED, the gap requirements and/or the gap and the NCSG requirements in the USIM-A may change. Similarly, if the USIM-B moves from the RRC_CONNECTED to the RRC_IDLE or the RRC_INACTIVE, the gap requirements and/or the gap and the NCSG requirements of the USIM_A which remains still in the RRC_CONNECTED may also change. At present there is no method by which the first network apparatus (i.e., NW-A) (200a) can know about such a change in gap requirements and/or gap and NCSG requirements, and the first network apparatus (i.e., NW-A) (200a) could affect the UE measurements or UE performance.

Unlike to the conventional methods and systems, let us consider two USIMs-USIM-A (technically the radio protocol stack associated with USIM-A) and the USIM-B (technically the radio protocol stack associated with USIM-B) and their corresponding network be first network apparatus (i.e., NW-A) (200a) and the second network apparatus (i.e., NW-B) (200b). The network in the proposed method mainly means NG-RAN through a core network is not excluded for some of the functionalities. Let us assume, the UE-A is in the RRC_CONNECTED with the first network apparatus (i.e., NW-A) (200a) and the UE-B is in the RRC_IDLE or the RRC_INACTIVE.

In an embodiment, in the MUSIM device which supports multiple simultaneous RRC Connections, when one USIM (for e.g. USIM-A) is in the RRC_CONNECTED and other USIM (for e.g. USIM-B) is transitioning from the RRC_IDLE or RRC_INACTIVE to RRC_CONNECTED or from the RRC_INACTIVE or the RRC_IDLE to the RRC_CONNECTED, the RRC_CONNECTED USIM (i.e. USIM which is continuing in RRC_CONNECTED, USIM-A here) reports at least one of the change in the gap requirements or gap and NCSG requirements to its first network apparatus (i.e., NW-A) if it is configured to do so.

In an embodiment, the USIM-A may report the change in NR gap requirements by sending a NeedForGapsInfoNR and the change in gap and NCSG requirements for the NR bands by sending the NeedForNCSG-InfoNR and the change in gap and NCSG requirements for E-UTRA bands by sending a NeedForNCSG-InfoEUTRA.

In an embodiment, the USIM-A includes at least one of the gap requirements or gap and NCSG requirements in the UE Assistance Information message or any other RRC message which is sent by the USIM-A to the first network apparatus (i.e., NW-A) (200a) to indicate that its capabilities and gap requirements have changed due to MUSIM operations like transition in other USIM from the RRC_IDLE or the RRC_INACTIVE to the RRC_CONNECTED or from the RRC_CONNECTED to the RRC_IDLE or the RRC_INACTIVE.

In an embodiment, the USIM-A reports the gap requirements and/or gap and NCSG requirements to the first network apparatus (i.e., NW-A) (200a) only if the gap requirements and/or gap and NCSG requirements have changed respectively from the last time the gap requirements or gap and NCSG requirements have been reported.

In an embodiment, the USIM-A reports the gap requirements (and/or gap and NCSG requirements) to the first network apparatus (i.e., NW-A) (200a) even if the gap requirements (and/or gap and NCSG requirements) have not changed from the last time the gap requirements (and/or gap and NCSG requirements) have been reported by the USIM-A to the first network apparatus (i.e., NW-A) (200a), when new bands are supported by the USIM-A due to the RRC state transition in the USIM-B or when existing bands supported by the USIM-A are not supported by the USIM-A due to the RRC state transition in the USIM-B.

If the MUSIM UE (100) has been configured with the band filter for reporting gap requirements (for e.g. requestedTargetBandFilterNR as in current NR specification) and/or gaps and NCSG requirements (for e.g. requestedTargetBandFilterNCSG-NR for NR bands as in current NR specification andrequestedTargetBandFilterNCSG-EUTRA for E-UTRA bands as in current NR specification), the MUSIM UE (100) reports the gap requirements or gap and NCSG requirements for the bands included in the band filter. In other words, the MUSIM UE (100) reports gap requirements only for the bands in requestedTargetBandFilterNR if requestedTargetBandFilterNR is configured and gaps and NCSG requirements for NR bands only for the bands in requestedTargetBandFilterNCSG ifrequestedTargetBandFilterNCSG is configured and gaps and NCSG requirements for E-UTRA bands only for the bands in requestedTargetBandFilterNCSG-EUTRA if requestedTargetBandFilterNCSG-EUTRA is configured.

In an embodiment, when the band capability has been changed in the USIM-A due to transition in the USIM-B from the RRC_IDLE or the RRC_INACTIVE to the RRC_CONNECTED and the band filter has been configured in the USIM-A, the USIM-A reports gap requirements and/or gap and the NCSG requirements only for the bands supported by the USIM-A after capability change due to transition from the RRC_IDLE or the RRC_INACTIVE to the RRC_CONNECTED and is present in band filter. In other words, the USIM-A reports the gap requirements and/or gap and NCSG requirements for the subset of bands in requestedTargetBandFilterNR or requestedTargetBandFilterNCSG or requestedTargetBandFilterNCSG-EUTRA and the reduced capability of USIM-A due to USIM-B's transition. In other words, if any of the configured requestedTargetBandFilterNR or requestedTargetBandFilterNCSG or requestedTargetBandFilterNCSG-EUTRA contains the bands which are not supported by the USIM-A after the change in RF capabilities at USIM-A due to the transition of USIM-B from RRC_IDLE or RRC_INACTIVE to RRC_CONNECTED, the USIM-A doesn't report the gap requirements and/or gap and NCSG requirements for those bands.

If the band filter is not configured at the USIM-A, the USIM-A reports the gap requirements and/or gap and NCSG requirements for all the bands that are supported after change in capabilities due to actions in the USIM-B like the transition in RRC States in the USIM-B.

In an alternate embodiment, the USIM-A may report the gap requirements and/or gap and the NCSG requirements for all the bands or all the bands included in the band filter that are supported before the capability change due to the transition of the USIM-B from the RRC_IDLE or the RRC_INACTIVE to the RRC_CONNECTED.

In an embodiment, the USIM-A may report at least one of gap requirements and/or gap and NCSG requirements to the first network apparatus (i.e., NW-A) (200a) as mentioned in above embodiments before executing the transition of the USIM-B from the RRC_IDLE or the RRC_INACTIVE to the RRC_CONNECTED or from the RRC_CONNECTED to the RRC_INACTIVE or the RRC_IDLE. i.e. the UE (100) sends the gap requirements or gap and NCSG requirements to the first network apparatus (i.e., NW-A) (200) and then waits for the RRC Reconfiguration before performing transition in the USIM-B.

Alternatively, the USIM-A may report at least one of the gap requirements or the gap and the NCSG requirements as mentioned in above embodiments after executing the transition of the USIM-B from the RRC_IDLE or the RRC_INACTIVE to the RRC_CONNECTED or from the RRC_INACTIVE or the RRC_IDLE to the RRC_CONNECTED.

In an embodiment, the USIM-A may report the gap requirements and/or the gap and the NCSG requirements in a RRC message like RRC Reconfiguration Complete which is send in response to the RRC Reconfiguration message that configures the USIM-A to allow the RRC state transition of the USIM-B, for e.g. to give a portion of its resources like RF resources to the USIM-B.

In an embodiment, the first network apparatus (i.e., NW-A) (200a) informs the USIM-A whether to send gap requirements and/or gap and NCSG requirements when the MUSIM capability changes. The first network apparatus (200a) informs the USIM-A whether the UE needs to send updated capability information (changed capabilities like physical layer capabilities, layer 2 capabilities, band capabilities and all other capabilities that may be changed due to other USIM changes RRC State). The information may be send using otherConfig—for e.g. using otherconfig IE like Musim-Capability AssistanceConfig which may be commonly used for both capability change and gap/NCSG requirement change.

In an embodiment, the first network apparatus (i.e., NW-A) (200a) informs the USIM-A whether to send the gap requirements and/or the gap and the NCSG requirements through the RRC message. This could be done in a way by sending an indication as in the Musim-Capability AssistanceConfig. In other words, whether to send the gap requirements and/or gap and NCSG requirements due to MUSIM actions may be send separately from whether to send changed capabilities. The MUSIM UE (100) sends gap requirements and/or gap and NCSG requirements only if it receives both Musim-Capability AssistanceConfig and the additional indication in Musim-Capability AssistanceConfig on whether to send gap requirements and/or gap and NCSG requirements during capability change due to operations in other USIM. There may be additional indications send for GapConfig and NCSGConfig for NR and EUTRA.

In another embodiment, the USIM-A sends the gap requirements and/or the gap and the NCSG requirements if MUSIM UE (100) receives the indication to send an updated capability (for e.g. as in Musim-CapabilityAssistanceConfig). In an additional embodiment, the USIM-A sends gap requirements and/or gap and NCSG requirements to the first network apparatus (i.e., NW-A) (200a) if it receives the Musim-Capability AssistanceConfig and one or more of configurations to report NeedForGaps or NeedForNCSG as in NeedForGapsConfigNR or NeedForNCSG-ConfigNRor NeedForNCSG-CibfugEUTRA from the first network apparatus (i.e., NW-A) (200a). That is, the USIM-A reports the gap requirements and/or gap and NCSG requirements due to MUSIM actions based on both the configuration to send changed capabilities for MUSIM operations and the general configuration to report gap requirements or gap and NCSG requirements.

In an additional embodiment, the USIM-A may report the gap requirements and/or gap and NCSG requirements when the USIM-B is configured or released with carrier aggregation or dual connectivity or any such actions in the USIM-B which can change the gap requirements and/or gap and NCSG. The actions may include removal or addition of second SIM, DSDS mode of operation activation/deactivation/DSDA mode of operation activation/deactivation, Mobility across Rel17 and Rel18 cell/network etc.

In an embodiment, the first network apparatus (i.e., NW-A) (200a) might inform the USIM-A whether to report the change in gap requirements and/or gap and NCSG requirements based on the USIM-B actions other than RRC State change. This could be an indication to report detailed capability change based on the USIM-B actions.

In an additional embodiment, the USIM-A might be configured with a timer which prevents the USIM-A to report the change of capabilities or change in the gap requirements and/or the gap and the NCSG requirement to the first network apparatus (i.e., NW-A) (200a) due to the MUSIM operations. The timer starts once the USIM-A send the change of capabilities or change in gap requirements and/or gap and NCSG requirements is send to the first network apparatus (i.e., NW-A) (200a). The USIM-A doesn't report any change of capabilities or change in the gap requirements or gap and NCSG requirement to the first network apparatus (i.e., NW-A) (200a) till the timer is stopped or expired. The timer may be restarted if the USIM-A receive a different configuration (including a different timer value or even other configuration) additionally, there could be different timers for reporting detailed capability change based on the USIM-B actions. The timer for detailed reporting may be started when change of capabilities or change in gap/gap and NCSG requirements is send and may be stopped when a different configuration is received.

In another embodiment, the first network apparatus (i.e., NW-A) (200a) informs the USIM-A whether to report the change of capabilities or change in gap requirements and/or gap and NCSG requirements separately when the capabilities has increased or capabilities has decreased due to the actions in the USIM-B.

In an embodiment, a source gNB transfers the gap requirements and/or gap and the NCSG requirements and the changed capabilities received in a UE Assistance Information (UAI) due to the MUSIM operations to a target gNB during handover.

The set of example changes in RRC spec TS38.331 due to some of the above embodiments is given below:

```
    5.3.5.9 Other configuration
    1> if the received other Config includes the musim-
CapabilityAssistanceConfig:
    2> if musim-CapabilityAssistanceConfig is set to setup:
```

```
    3> consider itself to be configured to provide MUSIM assistance
information on change of capabilities and gap/NCSG requirements
due to MUSIM operation in accordance with 5.7.4;
    2> else:
    3> consider itself not to be configured to provide MUSIM
assistance information on change of capabilities and gap/NCSG
requirements due to MUSIM operation and stop timer T3xxh, if
running;
    5.7.4 UE Assistance Information
    5.7.4.1 General
          The purpose of this procedure for the UE to inform the
      network of
          - its preference in being provisioned with reference
      time information, or;
          - its preference for FR2 UL gap, or;
          - its preference to transition out of RRC_CONNECTED
      state for MUSIM operation, or;
          - its preference on the MUSIM gaps, or;
          - the change in capabilities and the gap/NCSG
      requirements due to MUSIM operation, or;
          - its relaxation state for RLM measurements, or;
          - its relaxation state for BFD measurements, or;
          - availability of data mapped to radio bearers which
      are not configured for SDT, or;
    5.7.4.2 Initiation
          A UE capable of providing MUSIM assistance
  information may initiate the procedure if it was configured to do so,
  upon determining that it needs to leave RRC_CONNECTED state,
```

```
      or upon determining it needs the gaps, or upon change of the
      gap information without leaving RRC_CONNECTED state or upon
      change of capabilities or gap requirements due to MUSIM
      operation.
          Upon initiating the procedure, the UE shall:
          1> if configured to provide MUSIM assistance
      information on change of capabilities and gap/NCSG
      requirements due to MUSIM operation
          2> if the UE capabilities or gap/NCSG requirements has
      changed since the last time UE has informed UE capabilities
      or gap/NCSG requirements
          3> initiate transmission of the UEAssistanceInformation
      message in accordance with 5.7.4.3 to provide the current
      musim-GapPreferenceList;
    3> start the timer T3xxh with the timer value set to the
musim-CapabilityUpdate
              5.7.4.3 Actions related to transmission of
          UEAssistanceInformation message
        1>  if transmission of the UEAssistanceInformation
    message is initiated to provide MUSIM assistance information
    according to 5.7.4.2 or 5.3.5.3:
          2>if the UE has a preference for MUSIM periodic
      gap(s):
            3> include musim GapPreferenceList with an entry
        for each periodic gap the UE prefers to be configured;
              4>  set musim-Gaplength and musim-
          GapRepetitionAndOffsetin the musim-GapInfoIEto the
          values of the length and the repetition/offset of the
```

```
      gap(s), respectively, the UE prefers to be configured
      with;
      2> if the UE has a preference for MUSIM aperiodic gap:
        3> include the field musim-GapPreferenceList,
  with one entry for the aperiodic gap the UE prefers to
  be configured;
          4> set musim-Gaplength and musim-Starting-SEN-
      AndSubframe in the musim-GapInfoIEto the values of
      respectively the length and the starting SFN/subframe
      of the gap, respectively, the UE prefers to be
      configured with;
      2>else (if the UE has no longer preference for the
periodic/aperiodic gaps):
      3>  do not include musim-GapPreferenceList in the
  musim-Assistance IE;
    2>if UE has a preference to leave RRC_CONNECTED state
      3> set musim-PreferredRRC-State to the preferred
RRC state.
      2>If the UE prefers to change the capability for
MUSIM operations
      3> if the UE is configured to provide the
measurement gap requirement information of NR target
bands:
      4>  if the NeedForGapsInfoNR information is
  changed compared to last time the UE reported this
  information:
        5> include the NeedForGapsInfoNR and set
    the contents as follows:
```

```
          6> include intraFreq-needForGap and set
        the gap requirement information of intra-
        frequency measurement for each NR serving cell
        supported after capability change;
          6> if requestedTargetBandFilterNR is
        configured, for each NR band cell supported after
        capability change that is also included in
        requestedTargetBandFilterNR, include an entry in
        interFreq-needForGap and set the gap requirement
        information for that band; otherwise, include an
        entry in interFreq-needForGap and set the
        corresponding gap requirement information for
        each supported NR band;
    3>If the UE is configured to provide the measurement
gap and NCSG requirement information of NR target bands:
      4>  if the needForNCSG-InfoNR information is
  changed compared to last time the UE reported this
  information:
        5> include the NeedForNCSG-InfoNR and set
    the contents as follows :
          6> include intraFreq-needForNCSG and set
      the gap and NCSG requirement information of
      intra-frequency measurement for each NR serving
      cell supported after capability change;
          6> if requestedTargetBandFilterNCSG-NR is
      configured, for each NR band cell supported after
      capability change included in
      requestedTargetBandFilterNCSG-NR, include an
      entry in interFreq-needForNCSG and set the NCSG
```

```
      requirement information for that band; otherwise,
      include an entry for each supported NR band in
      interFreq-needForNCSG and set the corresponding
      NCSG requirement information;
    3> if the UE is configured to provide the
measurement gap and NCSG requirement information of
E-UTRA target bands:
      4> if the needForNCSG-InfoEUTRA information is
  changed compared to last time the UE reported this
  information:
        5> include the NeedForNCSG-InfoEUTRA and
    set the contents as follows:
          6> if requestedTargetBandFilterNCSG-EUTRA
      is configured, for each E-UTRA band cell
      supported after capability change included in
      +requestedTargetBandFilterNCSG-EUTRA, include an
      entry in needForNCSG-EUTRA and set the NCSG
      requirement information for that band; otherwise,
      include an entry for each E-UTRA band cell
      supported after capability change in needForNCSG-
      EUTRA and set the corresponding NCSG requirement
      information;
```

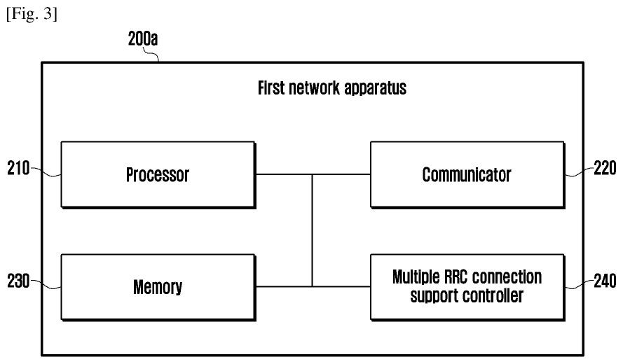

FIG. 2 shows various hardware components of the MUSIM UE (100), according to the embodiments as disclosed herein. In an embodiment, the MUSIM UE (100) includes a processor (110), a communicator (120), a memory (130), a multiple RRC connection support controller (140) and the plurality of SIMs (150a-150n). The processor (110) is coupled with the communicator (120), the memory (130), the multiple RRC connection support controller (140) and the plurality of SIMs (150a-150n).

The multiple RRC connection support controller (140) detects the event associated with the second SIM (150b) of the plurality of SIMs (150a-150n) when the first SIM (150a) of the plurality of SIMs (150a-150n) is in the connected state. The first SIM (150a) is associated with the first network apparatus (200a) and the second SIM (150b) is associated with the second network apparatus (200b). Based on the event associated with the second SIM (150b), the multiple RRC connection support controller (140) determines the MUSIM operation comprising the change in capability of at least one of the measurement gap and the NCSG.

Further, the multiple RRC connection support controller (140) sends the assistance information for the MUSIM operation using the first SIM (150a) to the first network apparatus (200a). In an embodiment, the multiple RRC connection support controller (140) detects whether the band filter is configured at the multiple RRC connection support controller (140) by the first network apparatus (200a) for reporting the change in capability of at least one of the measurement gap and the NCSG. In an embodiment, the multiple RRC connection support controller (140) sends the assistance information for the MUSIM operation for bands included in the band filter, when the band filter is configured at the multiple RRC connection support controller (140). In another embodiment, the multiple RRC connection support controller (140) sends the assistance information for the MUSIM operation for all bands that are supported after change in capabilities based on the event associated with the second SIM (150b), when the band filter is not configured at the multiple RRC connection support controller (140) by the first network apparatus (200a). The assistance information is send in the UEAssistanceInformation RRC message. Alternatively, the assistance information is included in the response message.

Based on the change in capability of at least one of the measurement gap and the NCSG, the multiple RRC connection support controller (140) receives the request message with the gap configuration. The request message is one of the RRC Reconfiguration message and the RRC Resume message.

Further, the multiple RRC connection support controller (140) configures the received gap configuration from the first network apparatus (200a). Further, the multiple RRC connection support controller (140) sends the response message to the first network apparatus (200a). The response message is one of the RRC Reconfiguration complete message, and the RRC Resume Complete message.

Further, the multiple RRC connection support controller (140) sends the assistance information for the MUSIM operation for the bands included in the band filter in one of the requestedTargetBandFilterNR message, the requestedTargetBandFilterNCSG message, and the requestedTargetBandFilterNCSG-EUTRA message.

Further, the multiple RRC connection support controller (140) receives the indication to send the change in capabilities of the multiple RRC connection support controller (140) from the first network apparatus (200a). Upon receiving the indication from the first network apparatus (200a), the multiple RRC connection support controller (140) sends the assistance information for the MUSIM operation using the first SIM (150a) to the first network apparatus (200a). The indication is received in one of the Musim-Capability AssistanceConfig IE, the NeedForGaps IE, the NeedForNCSG IE, the NeedForGapsConfigNR IE, the NeedForNCSG-ConfigNR IE, and the NeedForNCSG-ConfigEUTRA IE contained in at least one of the RRC Reconfiguration message and the RRC Resume message.

Further, the multiple RRC connection support controller (140) initiates the timer after sending the assistance information for the MUSIM operation to the first network apparatus (200a), where the multiple RRC connection support controller (140) does not report any change of capabilities or change in the gap requirements or gap and the NCSG requirement to the first network apparatus (200a) till the timer is stopped or expired.

Further, the multiple RRC connection support controller (140) pauses the measurements which require changed measurement gaps as send in the response message, receives the new RRC Reconfiguation message according to the changed capabilities, applies the received gap configuration and resumes the measurements.

The multiple RRC connection support controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. The term “non-transitory” should not be interpreted that the memory (130) is non-movable. In certain examples, a non-transitory storage medium may store data that can, over time, change (e.g., in Random Access Memory (RAM) or cache).

Although the FIG. 2 shows various hardware components of the MUSIM UE (100) but it is to be understood that other embodiments are not limited thereon. In other embodiments, the MUSIM UE (100) may include less or more number of components. Further, the labels or names of the components are used only for illustrative purpose and does not limit the scope of the invention. One or more components can be combined together to perform same or substantially similar function in the MUSIM UE (100).

FIG. 3 shows various hardware components of the first network apparatus (200a), according to the embodiments as disclosed herein. In an embodiment, the first network apparatus (200a) includes a processor (210), a communicator (220), a memory (230) and a multiple RRC connection support controller (240). The processor (210) is coupled with the communicator (220), the memory (230) and the multiple RRC connection support controller (240).

The multiple RRC connection support controller (240) sends the indication to the MUSIM UE (100) for the MUSIM operation. The MUSIM operation includes reporting the change in capabilities of at least one of the measurement gap and the NCSG based on the event associated with the second SIM (150b) of the plurality of SIMS (150a-150b) of the MUSIM UE (100). The indication is sent in one of the Musim-Capability AssistanceConfig IE, the NeedForGaps IE, the NeedForNCSG IE, the NeedForGapsConfigNR IE, the NeedForNCSG-ConfigNR IE, and the NeedForNCSG-CibfugEUTRA IE within the RRC Reconfiguration message or the RRC Resume message.

Further, the multiple RRC connection support controller (240) receives the assistance information for the MUSIM operation from the MUSIM UE (100) using the first SIM (150a) of the plurality of SIMs (150a-150n) of the MUSIM UE (100) in response to the indication. In an embodiment, the multiple RRC connection support controller (240) receives the assistance information for the MUSIM operation for bands included in the band filter, when the band filter is configured at the MUSIM UE (100) by the first network apparatus (200a). In another embodiment, the multiple RRC connection support controller (240) receives the assistance information for the MUSIM operation for all bands that are supported after change in capabilities based on the event associated with the second SIM (150b), when the band filter is not configured at the MUSIM UE (100) by the first network apparatus (200a).

Based on the change in capability of at least one of the measurement gap and the NCSG, the multiple RRC connection support controller (240) sends the request message with the gap configuration. Further, the multiple RRC connection support controller (240) receives the response message from the MUSIM UE (100) indicating configuration of the gap configuration at the MUSIM UE (100).

In an embodiment, the multiple RRC connection support controller (240) transfers the change in capability of at least one of the measurement gap and the NCSG at the MUSIM UE (100) to MUSIM operator of a target network apparatus during handover.

In another embodiment, the multiple RRC connection support controller (240) sends the band filter to the MUSIM UE (100) for reporting the change in capability of at least one of the measurement gap and the NCSG.

In an embodiment, the multiple RRC connection support controller (240) sends the assistance information for the MUSIM operation for the bands included in the band filter in one of the requestedTargetBandFilterNR message, the requestedTargetBandFilterNCSG message, and the requestedTargetBandFilterNCSG-EUTRA message.

The multiple RRC connection support controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 3 shows various hardware components of the first network apparatus (200a) but it is to be understood that other embodiments are not limited thereon. In other embodiments, the first network apparatus (200a) may include less or more number of components. Further, the labels or names of the components are used only for illustrative purpose and does not limit the scope of the invention. One or more components can be combined together to perform same or substantially similar function in the first network apparatus (200a).

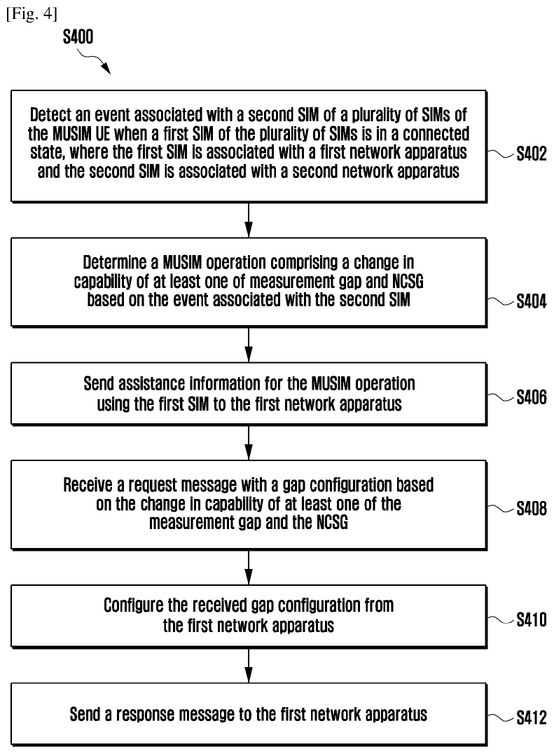

FIG. 4 is a flow chart (S400) illustrating a method implemented, by the MUSIM UE (100), for managing the multiple RRC connections support of the MUSIM UE (100) in the wireless network (1000), according to the embodiments as disclosed herein. The operations (S402-S412) are handled by the multiple RRC connection support controller (140).

At step S402, the method includes detecting the event associated with the second SIM (150b) of the plurality of SIMs (150a-150n) of the MUSIM UE (100) when the first SIM (150a) of the plurality of SIMs (150a-150n) is in the connected state. The first SIM (150a) is associated with the first network apparatus (200a) and the second SIM (150b) is associated with the second network apparatus (200b). At step S404, the method includes determining the MUSIM operation comprising the change in capability of at least one of the measurement gap and the NCSG based on the event associated with the second SIM (150b).

At step S406, the method includes sending the assistance information for the MUSIM operation using the first SIM (150a) to the first network apparatus (200a). At step S408, the method includes receiving the request message with the gap configuration based on the change in capability of at least one of the measurement gap and the NCSG. At step S410, the method includes configuring the received gap configuration from the first network apparatus (200a). At step S412, the method includes sending the response message to the first network apparatus (200a).

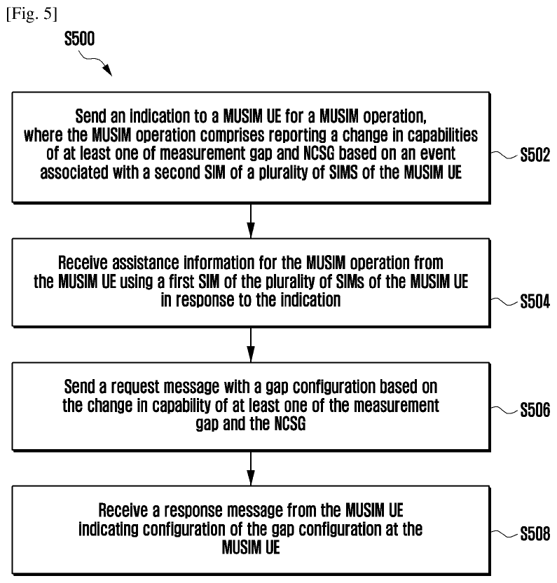

FIG. 5 is a flow chart (S500) illustrating a method implemented, by the first network apparatus (200a), for managing the multiple RRC connections support of the MUSIM UE (100) in the wireless network (1000), according to the embodiments as disclosed herein. The operations (S502-S508) are handled by the multiple RRC connection support controller (240).

At step S502, the method includes sending the indication to the MUSIM UE (100) for the MUSIM operation. The MUSIM operation includes reporting the change in capabilities of at least one of measurement gap and NCSG based on the event associated with the second SIM (150b) of the plurality of SIMS (150a-150n) of the MUSIM UE (100). At step S504, the method includes receiving the assistance information for the MUSIM operation from the MUSIM UE (100) using the first SIM (150a) of the plurality of SIMs (150a-150n) of the MUSIM UE (100) in response to the indication. At step S506, the method includes sending the request message with the gap configuration based on the change in capability of at least one of the measurement gap and the NCSG. At step S508, the method includes receiving the response message from the MUSIM UE (100) indicating configuration of the gap configuration at the MUSIM UE (100).

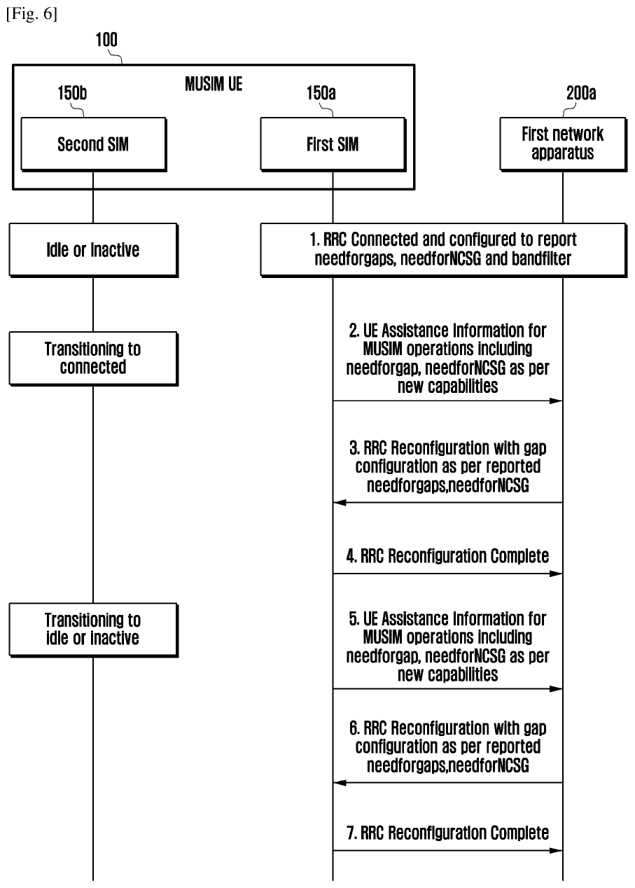

FIG. 6 is an example flow diagram illustrating a scenario of reporting gap requirements, according to the embodiments as disclosed herein.

At step 1, the first SIM (150a) is in the RRC connected mode and configured to report the needforgaps, the needforNCSG and the bandfilter to the first network apparatus (200a). The second SIM (150b) transitions to connected mode. At step 2, the first SIM (150a) sends the UE assistance information for the MUSIM operations including the needforgap, and the needforNCSG as per new capabilities to the first network apparatus (200a). At step 3, the first network apparatus (200a) sends the RRC Reconfiguration with the gap configuration as per reported needforgaps, and the needforNCSG to the first SIM (150a). At step 4, the first SIM (150a) sends the RRC reconfiguration complete to the first network apparatus (200a).

The second SIM (150b) transitions to the idle mode or the inactive mode. At step 5, the first SIM (150a) sends the UE assistance information for the MUSIM operations including the needforgap and the needforNCSG as per new capabilities to the first network apparatus (200a). At step 6, the first network apparatus (200a) sends the RRC Reconfiguration with gap configuration as per reported needforgaps, needforNCSG to the first SIM (150a). At step 7, the first SIM (150a) sends the RRC Reconfiguration Complete to the first network apparatus (200a).

The various actions, acts, blocks, steps, or the like in the flow charts (S400 and S500) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-15. (canceled)

16. A method performed by a user equipment (UE) in a wireless communication system, the method comprising:
receiving, from a base station, a radio resource control (RRC) message including first information;
identifying whether a current measurement gap requirement information is different from an indicated in a last transmission of a UE assistance information message including information to indicate measurement gap requirement information of the UE associated with a multi-subscriber identity module (MUSIM) for a new radio (NR) target band; and
in case that the current measurement gap requirement information is different from the indicated in the last transmission of the UE assistance information message, transmitting, to the base station, another UE assistance information message including the information to indicate the measurement gap requirement information of the UE associated with the MUSIM for the NR target band,
wherein the first information configures that the UE is allowed to provide assistance information of the MUSIM for a gap.

17. The method of claim 16, further comprising:
identifying whether a measurement gap is required for the UE to perform a measurement on the NR target band.

18. The method of claim 16, further comprising:
in case that the transmitting the another UE assistance information message is initiated to provide the information, performing the information to include a field indicating measurement gap requirement information for a NR intra-frequency measurement and to set the measurement gap requirement information for each supported NR cell.

19. The method of claim 18, further comprising:
identifying whether a field indicating the NR target band is configured,
wherein at least one of RRC reconfiguration complete message or RRC resume complete message includes the information to indicate the measurement gap requirement information of the UE associated with the MUSIM for the NR target band.

20. A method performed by a base station in a wireless communication system, the method comprising:
transmitting, to a user equipment (UE), a radio resource control (RRC) message including first information; and
in case that a current measurement gap requirement information is different from an indicated in a last transmission of a UE assistance information message including information to indicate measurement gap requirement information of the UE associated with a multi-subscriber identity module (MUSIM) for a new radio (NR) target band, receiving, from the UE, another UE assistance information message including the information to indicate the measurement gap requirement information of the UE associated with the MUSIM for the NR target band,
wherein the first information configures that the UE is allowed to provide assistance information of the MUSIM for a gap.

21. The method of claim 20,
wherein a measurement gap is required for the UE to perform a measurement on the NR target band is identified

22. The method of claim 20, further comprising:
wherein in case that a transmission from the UE to the base station of the another UE assistance information message is initiated to provide the information, the information includes a field indicating measurement gap requirement information for a NR intra-frequency measurement and the measurement gap requirement information is set for each supported NR cell.

23. The method of claim 22,
whether a field indicating the NR target band is configured is identified, and
wherein at least one of RRC reconfiguration complete message or RRC resume complete message includes the information to indicate the measurement gap requirement information of the UE associated with the MUSIM for the NR target band.

24. A user equipment (UE) in a wireless communication system, the UE comprising:
a transceiver; and
a controller coupled with the transceiver,
wherein the controller is configured to:
receive, from a base station, a radio resource control (RRC) message including first information;
identify whether a current measurement gap requirement information is different from an indicated in a last transmission of a UE assistance information message including information to indicate measurement gap requirement information of the UE associated with a multi-subscriber identity module (MUSIM) for a new radio (NR) target band; and
in case that the current measurement gap requirement information is different from the indicated in the last transmission of the UE assistance information message, transmit, to the base station, another UE assistance information message including the information to indicate the measurement gap requirement information of the UE associated with the MUSIM for the NR target band, and
wherein the first information configures that the UE is allowed to provide assistance information of the MUSIM for a gap.

25. The UE of claim 24, wherein the controller is further configured to:
identifying whether a measurement gap is required for the UE to perform a measurement on the NR target band.

26. The UE of claim 24, wherein the controller is further configured to:
in case that the transmitting the another UE assistance information message is initiated to provide the information, perform the information to include a field indicating measurement gap requirement information for a NR intra-frequency measurement and to set the measurement gap requirement information for each supported NR cell.

27. The UE of claim 26,
wherein the controller is further configured to identify whether a field indicating the NR target band is configured, and
wherein at least one of RRC reconfiguration complete message or RRC resume complete message includes the information to indicate the measurement gap requirement information of the UE associated with the MUSIM for the NR target band.

28. A base station in a wireless communication system, the base station comprising:
a transceiver; and
a controller coupled with the transceiver,
wherein the controller is configured to:
transmit, to a user equipment (UE), a radio resource control (RRC) message including first information; and
in case that a current measurement gap requirement information is different from an indicated in a last transmission of a UE assistance information message including information to indicate measurement gap requirement information of the UE associated with a multi-subscriber identity module (MUSIM) for a new radio (NR) target band, receive, from the UE, another UE assistance information message including the information to indicate the measurement gap requirement information of the UE associated with the MUSIM for the NR target band,
wherein the first information configures that the UE is allowed to provide assistance information of the MUSIM for a gap.

29. The base station of claim 28,
wherein a measurement gap is required for the UE to perform a measurement on the NR target band is identified

30. The base station of claim 28,
wherein in case that a transmission from the UE to the base station of the another UE assistance information message is initiated to provide the information, the information includes a field indicating measurement gap requirement information for a NR intra-frequency measurement and the measurement gap requirement information is set for each supported NR cell,
wherein a field indicating the NR target band is configured is identified, and
wherein at least one of RRC reconfiguration complete message or RRC resume complete message includes the information to indicate the measurement gap requirement information of the UE associated with the MUSIM for the NR target band.
